(19) United States
(12) Patent Application Publication
(10) Pub. No.: US 2014/0240888 A1
(43) Pub. Date: Aug. 28, 2014

(54) ALTERNATING CURRENT POWER CABLE

(71) Applicants: HONG FU JIN PRECISION INDUSTRY (WuHan) CO., LTD., (US); HON HAI PRECISION INDUSTRY CO., LTD., New Taipei (TW)

(72) Inventors: YONG-JUN SONG, Wuhan (CN); YONG-ZHAO HUANG, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/869,262

(22) Filed: Apr. 24, 2013

(30) Foreign Application Priority Data
Feb. 26, 2013 (CN) 2013100605033

(51) Int. Cl. H05F 3/04

(52) U.S. Cl. CPC H05F 3/04
USPC 361/220

(57) ABSTRACT

An alternating current (AC) power cable includes discharge electrodes, a relay, and an electromagnetic coil with two windings. The relay includes an induction coil with two ends. The two ends of the induction coil are respectively connected to two ends of the electromagnetic coil. The discharge electrodes include a first discharge electrode and a second discharge electrode. The first discharge electrode is connected to the neutral wire of the AC power cable. The second discharge electrode is connected to the relay. When the AC power cable has residual charge, current is induced by the electromagnetic in the induction coil. The induction coil converts the current to magnetic force to close the relay. The residual charge is transmitted to the discharge electrodes through the relay.

### BACKGROUND

1. Technical Field

The present disclosure relates to an alternating current power cable.

2. Description of Related Art

Residual charges may remain in power cables even after being unplugged from a power source. These charges can be hazardous and damage electronic devices connected to the cables. Thus, improved power cables are needed.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an isometric view of an embodiment of an alternating current (AC) power cable.

FIG. 2 is a circuit diagram of the AC power cable of FIG. 1.

### DETAILED DESCRIPTION

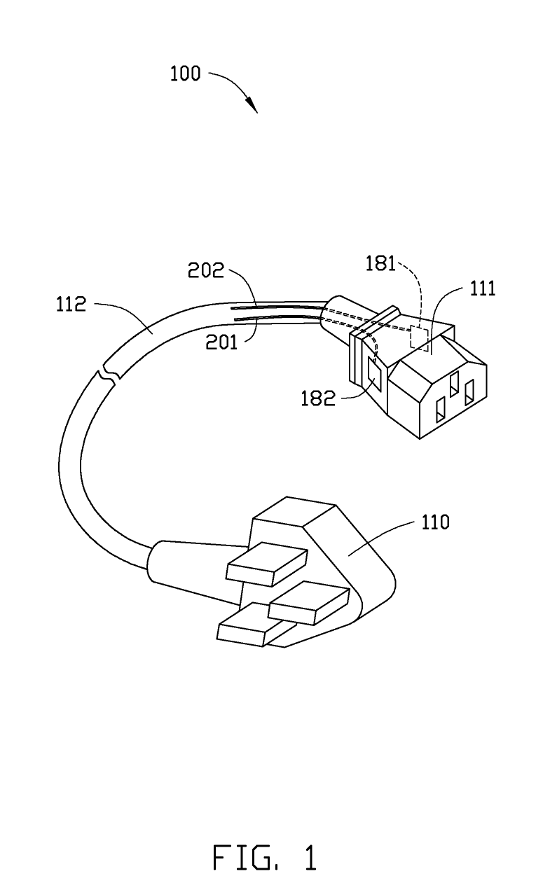

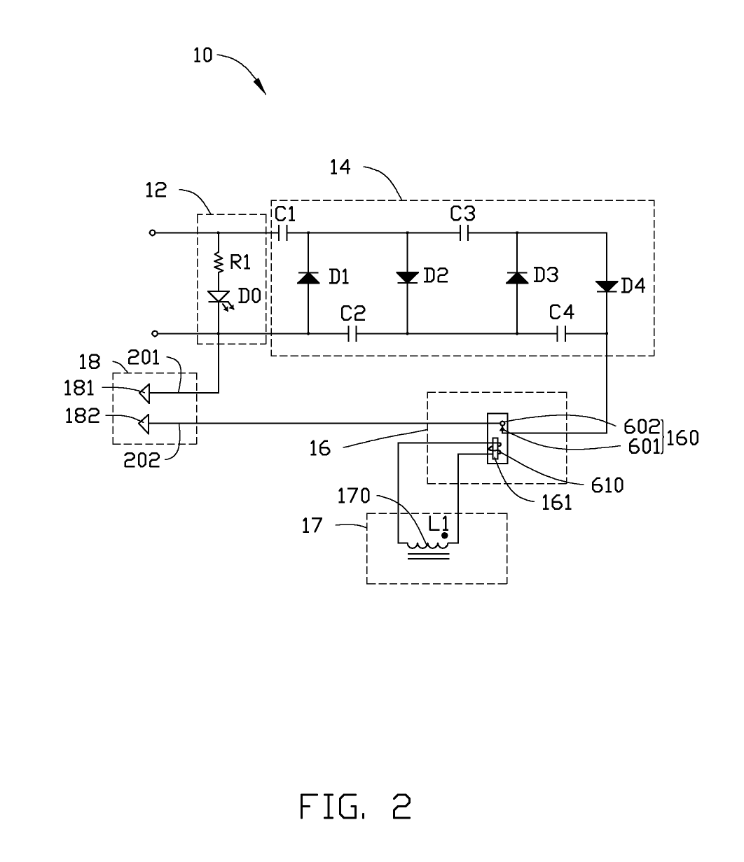

FIG. 1 and FIG. 2 show an embodiment of an alternating current (AC) power cable 100 including a first plug 110, a second plug 111, a cable 112 connected between the first plug 110 and the second plug 111, and an AC detecting device 10. The first plug 110 is used to connect to a power source such as 110 volt (V) AC. The second plug 111 is used to connect to an electronic device for providing the 110V AC power source to the electronic device.

The AC detecting device 10 includes an alarm module 12, an amplifier module 14, a relay 16, an electromagnetic coil 17, and two discharge electrodes 18. In the embodiment, the alarm module 12 and the amplifier module 14 are both set inside an insulated shell of the first plug 110. The alarm module 12 is used to warn testers whether the AC power cable 100 has residual charges or not. The amplifier module 14 is used to amplify the voltage of the 110V AC power source. The electromagnetic coil 17 includes an electromagnetic winding 170 set in any position inside the insulated shell of the cable 112 and encircling but not contacting the wires of the AC power cable 100. The relay 16 is set inside the insulation shell of the second plug 111.

The alarm module 12 includes a resistor R1 and a light emitting diode (LED) D0. A first end of the resistor R1 is connected to the live wire of the AC power cable 100. A second end of the resistor R1 is connected to the anode of the LED D0. A cathode of the LED D0 is connected to the neutral wire of the AC power cable 100.

The amplifier module 14 includes four capacitors C1-C4 and four diodes D1-D4. A cathode of the first diode D1 is connected to the first end of the resistor R1 through the first capacitor C1. An anode of the first diode D1 is connected to the cathode of the light emitting diode D0. An anode of the second diode D2 is connected to the cathode of the first diode D1. A cathode of the second diode D2 is connected to the anode of the first diode D1 through the second capacitor C2. An anode of the third diode D3 is connected to the cathode of the second diode D2. A cathode of the third diode D3 is connected to the anode of the second diode D2 through the third capacitor C3. An anode of the fourth diode D4 is connected to the cathode of the third diode D3. A cathode of the fourth diode D4 is connected to the anode of the third diode D3 through the capacitor C4. The cathode of the fourth diode D4 is also connected to the relay 16.

The relay 16 includes a normally open switch 160 and an induction coil 161 with an induction winding 610. The normally open switch 160 includes a first contact 601 and a second contact 602. Two ends of the induction winding 610 are respectively connected to two ends of the electromagnetic winding 170.

The discharge electrodes 18 include a first discharge electrode 181 and a second discharge electrode 182. In the embodiment, the first discharge electrode 181 and the second discharge electrode 182 are exposed through opposite sidewalls of the second plug 111. The first discharge electrode 181 is connected to the neutral wire of the AC power cable 100 by a first wire 201. The second discharge electrode 182 is connected to the second contact 602 of the normally open switch 160 by a second wire 202. The first wire 201 and the second wire 202 are both partially exposed through the insulated shell of the cable 112. The first discharge electrode 181 and the second discharge electrode 182 are made of metal such as copper.

In use, during shut down of the electronic device, before all components have completely shut down, there may be residual charges in the AC power cable 100, in which case the LED DO is turned on and emits light. The electromagnetic coil 17 induces the charges in the cable 112 to transmit to the relay 16. The first contact 601 contacts the second contact 602 due to the magnetism produced by the induction coil 161. A first charge in the AC power cable is transmitted to the first discharge electrode 181. A second charge of about 500V is outputted from the amplifier module 14 generated before shut down of the electronic device and is transmitted to the second discharge electrode 182 through the closed relay 16. Therefore, a voltage difference exists between the first discharge electrode 181 and the second discharge electrode 182 after the first plug is disconnected from the AC power source. When the exposed first and second discharge electrodes 181, 182 on the second plug 111, or the first wire 201 and the second wire 202 are contacted when pulling out the AC power cable 100 from the electronic device, any static charge will be safely discharged between the first wire 201 and the second wire 202, thereby protecting the electronic device.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An alternating current (AC) power cable, comprising:
an amplifier module for amplifying remnant charge in the AC power cable after the AC power cable is disconnected from an AC power source;
a relay connected to an output of the amplifier module to receive the second remnant charge output from the amplifier module, the relay comprising a normally open switch with two contacts, and an induction coil with an induction winding, one of the contacts connected to the output of the amplifier module;
an electromagnetic coil comprising an electromagnetic winding connected to the induction winding;
a first discharge electrode connected to a neutral wire of the AC power cable and received a first remnant charge from the AC power cable; and
a second discharge electrode connected to the other contact of the normally open switch, wherein the electromagnetic coil induces charges in the AC power cable to transmit to the induction coil for allowing the two contacts to be contacted to each other and received the second remnant charge output from the amplifier module, thereby forming a voltage difference between the first discharge electrode and the second discharge electrode for discharging any static charges.

2. The AC power cable of claim 1, further comprising a first plug used to connect to the AC power source, a second plug used to connect to an electronic device, and a cable connected between the first plug and the second plug.

3. The AC power cable of claim 2, wherein the amplifier module is set inside an insulated shell of the first plug, the amplifier module comprises first to fourth capacitors and first to fourth diodes, a cathode of the first diode is connected to a live wire of the AC power cable through the first capacitor, an anode of the first diode is connected to the neutral wire of the AC power cable through the first capacitor, an anode of the second diode is connected to the cathode of the first diode, a cathode of the second diode is connected to the anode of the first diode through the second capacitor, an anode of the third diode is connected to the cathode of the second diode, a cathode of the third diode is connected to the anode of the second diode through the third capacitor, an anode of the fourth diode is connected to the cathode of the third diode, a cathode of the fourth diode is connected to the anode of the third diode through the fourth capacitor, the anode of the fourth diode is also connected to one of the contacts.

4. The AC power cable of claim 3, further comprising an alarm module located inside the insulated shell of the first plug for detecting and alarming whether the AC power cable has residual charges.

5. The AC power cable of claim 4, wherein the alarm module comprises a resistor and a light emitting diode (LED), a first end of the resistor is connected to the live wire of the AC power cable, a second end of the resistor is connected to an anode of the LED, a cathode of the LED is connected to the neutral wire of the AC power cable and also connected to the first discharge electrode.

6. The AC power cable of claim 5, wherein the electromagnetic coil is set inside the insulated shell of the cable and encircling but not contacting the wires of the AC power cable.

7. The AC power cable of claim 6, wherein the first discharge electrode and the second discharge electrode are exposed through opposite sidewalls of the second plug.

8. The AC power cable of claim 6, wherein the first discharge electrode is connected to the neutral wire by a first wire, and the second discharge electrode is connected to the other contact of the relay by a second wire.

9. The AC power cable of claim 8, wherein the first wire and the second wire are both partially exposed through the insulated shell of the cable.

10. The AC power cable of claim 9, wherein the first discharge electrode and the second discharge electrode are made of metal such as copper.
